(19) United States
(12) Patent Application Publication
(10) Pub. No.: US 2004/0025420 A1
(43) Pub. Date: Feb. 12, 2004

(54) Injection needle for injecting woody plants

(75) Inventors: Peter M. Wild, Winchester, MA (US); David E. Floyd, Marlborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Peter M. Wild, Winchester, MA

(21) Appl. No.: 10/434,407

(22) Filed: May 8, 2003

Related U.S. Application Data
(60) Provisional application No. 60/379,832, filed on May 9, 2002.

(51) Int. Cl. A01C 1/00

(52) U.S. Cl. 47/1.5

(57) ABSTRACT

The present invention includes a needle and method for injecting a fluid, such as a medicament, into a woody plant, e.g., trees, shrubs, or vines. In one embodiment, the needle includes a body having a proximal end, a distal end, an inner conduit extending from the proximal end towards the distal end, and at least one aperture in communication with the inner conduit and an outer surface of the body. An indentation in the outer surface of the body is provided where the aperture opens to the outer surface.

### RELATED APPLICATION

This application claims the benefit of U.S. Provisional Application No. 60/379,832, filed on May 9, 2002. The entire teachings of the above application are incorporated herein by reference.

### BACKGROUND OF THE INVENTION

Injection treatment of plants is a method of introducing an agent into a plant. The agent can be introduced into the plant by gravity or under pressure, and a wide variety of devices exist for injecting plants.

Injection treatment is useful for the treatment of disease conditions or insect infestation, such as Dutch Elm Disease, American Chestnut Blight, Woolly Adelgid, Red Palm Weevil, etc. Fungicides, insecticides, and chemicals can be administered by injection.

Nutritional supplements can also be administered by injection, to maintain, improve, or enhance the health of the plant. Such administration can also be an effective form of prevention of disease and insect attack, as many diseases and insects attack plants that are in suboptimal health or are otherwise stressed.

Many plants are quite valuable, especially in the case of slow-growing plants such as trees or woody vines (e.g., grapevines). A tree can take many years to grow to maturity, and it is therefore desirable to maintain adult trees in a healthy state, given the cost and inconvenience of removal and replacement of trees. Likewise, some woody plants, such as grapevines and fruit trees, are valuable because of their crop value, and the time required to bring a replacement plant to maturity is time during which the plant is not producing income.

In general, in administration of agents to trees, many devices require drilling a hole in the tree to allow insertion into the tree of all or a portion of the device. However, drilling a hole is injurious to the tree, and allows the entry of pathogens and insects to the interior of the tree. Most plants generally have mechanisms for “sealing off” a damaged site, but even so, such damage can stress the plant, making the plant susceptible, or even attractive, to insects and diseases.

Once an administration device is removed, the hole can be filled in with a plug or other means of filling in the hole. However, the plant has still been injured, and may become susceptible to subsequent attack by pests and diseases. In addition, diseases and pests can still enter at the join between the plug and the plant. Furthermore, leaving objects in a plant can retard or interfere with later growth of the plant.

### SUMMARY OF THE INVENTION

The present invention includes a needle for injecting a fluid, such as a medicament, into a woody plant, e.g., trees, shrubs, or vines. In one embodiment, the needle includes a body having a proximal end, a distal end, an inner conduit extending from the proximal end towards the distal end, and at least one aperture in communication with the inner conduit and an outer surface of the body. An indentation in the outer surface of the body is provided where the at least one aperture opens to the outer surface.

### BRIEF DESCRIPTION OF THE DRAWINGS

The foregoing and other objects, features and advantages of the invention will be apparent from the following more particular description of various embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of an injection needle that can be used with an inoculator to inject a fluid in accordance with one embodiment of the invention.

FIG. 2 is cross-sectional view of the needle shown in FIG. 1.

FIG. 3 is an enlarged detailed section of the distal end of the needle shown in FIG. 2.

FIG. 4 is a perspective view of an alternative embodiment of a needle in accordance with the present invention.

### DETAILED DESCRIPTION OF THE INVENTION

A description of various embodiments of the invention follows.

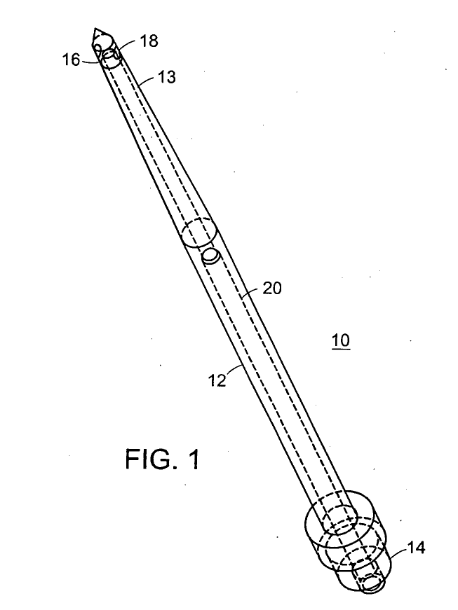

FIG. 1 is a perspective view of an injection needle 10 that can be used with an inoculator to inject a fluid, such as a medicament, into a woody plant, e.g., trees, shrubs, or vines. One example of an inoculator is illustrated in commonly assigned U.S. patent application Ser. No. 09/902,494, filed on Jul. 10, 2001 and corresponding International Publication WO 02/03778, published on Jan. 17, 2002, the entire teachings of which are incorporated herein by reference. Other examples of inoculators are disclosed in commonly assigned U.S. Provisional Application No. 60/433,064, filed on Dec. 12, 2002, the entire teachings of which are incorporated herein by reference.

Generally, the needle 10 includes a body 12 having an outer surface 13, a proximal end 14, a distal end 16, and at least one aperture 18 adjacent to the distal end 16. The proximal end 14 is adapted to be secured to the incubator or injector that delivers a fluid to be injected into the plant under pressure. Thus, an inner conduit 20 extends from the proximal end 14 to the distal end 16 to provide communication from the inner conduit 20 to one or more aperture(s) 18.

The needle 10 can be about 1.5 cm (0.6 inches) to about 5.0 cm (2.0 inches) long in one embodiment. In another embodiment, the needle 10 is about 2.5 cm (1.0 inch) to about 12.7 cm (5.0 inches) long. The purpose of this needle 10 is to inject the fluid into larger trees with deeply fissured bark, e.g. the needle can be used with deciduous and evergreen trees and shrubs. In another embodiment, the needle 10 is approximately 0.953 cm (0.375 inches) long, and the aperture(s) 18 are about 0.000317 cm (0.000125 inches). This needle 10 can be used for smooth barked evergreen or deciduous trees, shrubs and vines (e.g., grapevines). The needle 10 can be made of hardened and/or is formed of stainless steel or other similar material. In another embodiment, the needle 10 is 4.45 cm (1.75 inches) long with two apertures 18 of 0.081 cm (0.032 inches). In another embodiment, the needle 10 is 1.91 cm (0.75 inches) long with two apertures of 0.038 cm (0.015 inches).

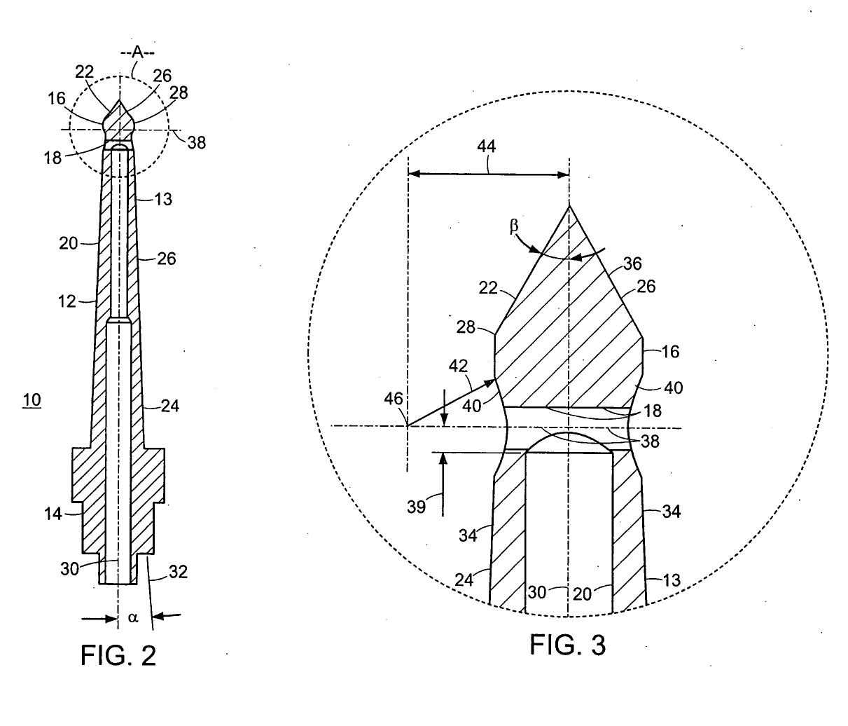

One embodiment of the needle 10 is cross-sectionally shown in FIG. 2. FIG. 3 is an enlarged detailed section A of FIG. 2 and illustrates the distal end 16. The distal end 16 has a sealed tip 22. One or more apertures 18 can have a diameter (d) in the range of between about 0.02 cm and about 0.1 cm (0.007 and 0.03 inches) in one embodiment. In another embodiment, the aperture(s) 18 are about 0.038 cm (0.015 inches) in diameter. In a further embodiment, the aperture(s) 18 are about 0.081 cm (0.032 inches) in diameter.

In one embodiment, the needle body 12 includes two portions, a first portion 24 and a second portion 26. The first portion 24 extends from the proximal end 14 of the needle to a shoulder point 28, and the second portion 26 extends from the shoulder point 28 to the distal end 16.

The first portion 24 of the needle 10 can be straight or can have a first taper. All or a part of the first portion 24 can be tapered. The first taper is measured by the angle α between the longitudinal axis 30 of the needle 10 and the outer surface 13, as indicated by exterior line 32 of the first portion 24 of the needle. The first taper can have an angle of between 0° and about 5° in particular embodiments. In one embodiment, the first taper is about 1°. In another embodiment, the first taper is about 1.5°.

It may be desirable for some uses to taper the first portion so as to increase the strength of the shaft while minimizing the width at the tip of the needle. The first taper can vary in relation to the overall length of the needle, allowing the means for attaching the needle to the injector to remain the same between different needles.

In a particular embodiment, the first portion 24 has a taper until about point 34, which is located below apertures 18. From point 34 to about shoulder point 28, the needle 10 can have a substantially uniform cross-section, i.e., non-tapered. It has been found that providing a substantially uniform cross-section adjacent the apertures 18 has beneficial performance characteristics, such as less clogging of the apertures 18 by the plant debris.

The second portion 26 has a second taper. The second taper is measured by the angle β between the longitudinal axis 30 of the needle 10 and the majority 36 of the outer surface of the second portion 26 of the needle. The second taper can have angle β in the range of between about 10 degrees and about 50 degrees relative to the longitudinal axis 30 of the needle 10. In another embodiment, the second taper can be about 20 degrees to about 40 degrees relative to the longitudinal axis 30 of the needle 10. In one embodiment, the second taper is 30 degrees relative to the longitudinal axis 30 of the needle 10.

As shown in FIG. 3, the needle 10 has at least one aperture 18 connecting the inner conduit 20 of the needle 10 with the outer surface 13 of the needle. The location at which the aperture 18 meets the outer surface 13 can be proximate to the distal end 12, and the sealed tip 22, of the needle 10. In one embodiment, the location at which the aperture 18 meets the outer surface 13 is proximate to the shoulder point 28. Placing the aperture 18 in this location, behind the shoulder point 28, reduces the incidence of plant debris breaking free from the plant and clogging the aperture 18.

In the case of a needle 10 with more than one aperture, the apertures 18 can be located on opposite sides of the needle for simpler and cheaper manufacture of the needle. With centerlines 38 of the apertures 18 colinear, a wire or rod can be inserted in one aperture 18 and pass through to the opposing aperture 18 to remove any plant debris that may become clogged therein. In a particular embodiment, the centerline 38 of the aperture 18 is positioned a distance 39 above the end of the inner conduit 20 to facilitate the proper deburring of the inner conduit 20. In a particular embodiment, the distance 39 can be in the range of about 0.12 and 0.38 mm (0.005 and 0.015 inches).

As shown in FIG. 3, an indentation 40 can be provided at a point in the needle 10 where the aperture 18 opens to the outer surface 13. It has been found that providing such an indentation 40 provides a geometry that reduces the likelihood of plant debris clogging the apertures 18. The radius of curvature 42 is optimally selected. A radius of curvature too small has the undesired effect of “cheese grating” the plant at the edges upon insertion or withdrawal of the needle from the plant where the indentation 40 meets the outer surface 13. In a particular embodiment, the center 46 of the radius 42 defining curvature is located a distance 44 from longitudinal axis 30 on the centerline 38. The radius of curvature 42 can be in the range of between about 1.27 and 1.78 mm (0.05 and 0.07 inches). In a particular embodiment, the radius of curvature is about 1.58 mm (0.006 inches). In alternative embodiments, a groove can be formed in the outer surface 13 around, or at least part of, the outer circumference of the body 12 to form the indentation 40. The groove can be chamfered, beveled, straight, V-shaped, C-shaped, channeled, or include other suitable geometry.

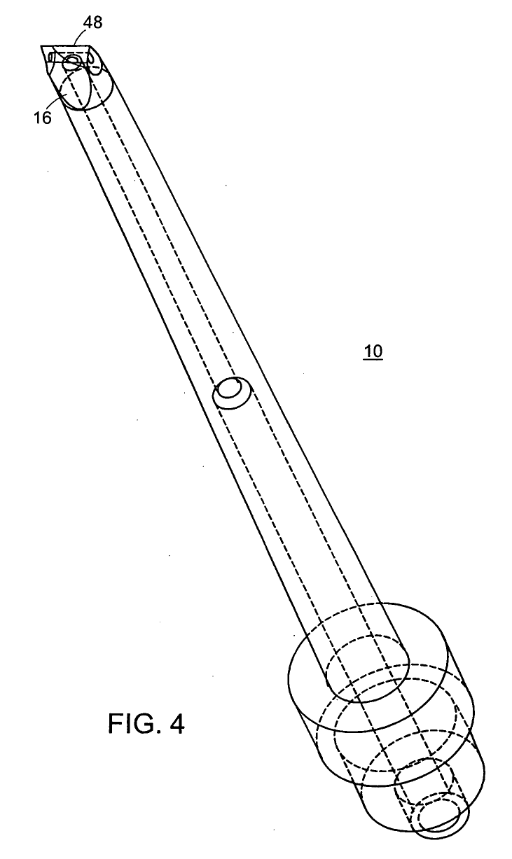

FIG. 4 is a perspective view of an alternative needle 10 in which the distal end 16 terminates in the shape of a chisel, i.e., a blade 48. This embodiment can be employed for injecting hard wood plants.

While this invention has been particularly shown and described with references to various embodiments thereof, it will be understood by those skilled in the art that various changes in form and details may be made therein without departing from the scope of the invention encompassed by the appended claims.

What is claimed is:

1. An injection needle for injecting a fluid into a woody plant comprising a body having a proximal end, a distal end, an inner conduit extending from the proximal end towards the distal end, and at least one aperture being in communication with the inner conduit and an outer surface of the body, there being an indentation in the outer surface of the body where the at least one aperture opens to the outer surface.

2. The injection needle of claim 1, further including a second aperture extending from the inner conduit to the outer surface of the body, there being a second indentation in the outer surface of the body where the second aperture opens to the outer surface.

3. The injection needle of claim 2, wherein a centerline of the at least one aperture and a centerline of the second aperture are colinear and form an angle of about 90 degrees relative to a longitudinal axis of the body.

4. The injection needle of claim 2, wherein the apertures are configured such that a wire can pass through the body.

5. The injection needle of claim 1, wherein the distal end terminates in a point.

6. The injection needle of claim 1, wherein the distal end terminates in a blade.

7. The injection needle of claim 1, wherein the indentation includes a radius of curvature.

8. The injection needle of claim 1, wherein the indentation includes a groove formed in at least part of the outer surface of the body.

9. The injection needle of claim 8, wherein the groove includes at least one cross-sectional shape selected from the group consisting of C-shape, V-shape, a chamfer, and a bevel.

10. The injection needle of claim 1, wherein the outer surface is countersunk to form the indentation.

11. The injection needle of claim 1, wherein the body includes a first tapered portion extending from the proximate end toward the distal end.

12. The injection needle of claim 11, wherein the body includes a substantially uniform cross-sectional diameter adjacent the at least one aperture.

13. An injection needle for injecting a fluid into a woody plant comprising a body having a proximal end, a distal end, an inner conduit extending from the proximal end towards the distal end, and a first aperture and a second aperture in communication with the inner conduit and an outer surface of the body, centerlines of the first aperture and the second aperture being colinear.

14. The injection needle of claim 13, wherein the outer surface includes indentations where the apertures open up to the outer surface.

15. A method for injecting a fluid into a woody plant, the method comprising:
(a) providing an injection needle for injecting the fluid, the needle including a body having a proximal end, a distal end, an inner conduit extending from the proximal end towards the distal end, and a first aperture and a second aperture in communication with the inner conduit and an outer surface of the body, centerlines of the first aperture and the second aperture being colinear;
(b) inserting the needle into the woody plant; and
(c) injecting the fluid through the inner conduit of the needle and out of at least one of the apertures and into the woody plant, thereby injecting the fluid into the woody plant.

16. The method of claim 15, further comprising providing an indentation in the body where the first and second apertures open up to the outer surface of the body.

17. The method of claim 15, further comprising providing a substantially uniform cross-sectional diameter of the body adjacent the first and second apertures.

18. A method for injecting a fluid into a woody plant, the method comprising:
(a) providing an injection needle for injecting the fluid, the needle including a body having a proximal end, a distal end, an inner conduit extending from the proximal end towards the distal end, and at least one aperture being in communication with the inner conduit and an outer surface of the body, there being an indentation in the outer surface of the body where the at least one aperture opens to the outer surface;
(b) inserting the needle into the woody plant; and
(c) injecting the fluid through the inner conduit of the needle and out of the at least one aperture and into the woody plant, thereby injecting the fluid into the woody plant.

19. The method of claim 18, further comprising providing a substantially uniform cross-sectional diameter of the body adjacent the at least one aperture.

20. The method of claim 18, further comprising providing a taper in the body from the proximal end toward the at least one aperture.
